(19) United States
(12) Patent Application Publication
(10) Pub. No.: US 2014/0368766 A1
(43) Pub. Date: Dec. 18, 2014

(54) DISPLAY ELEMENT

(71) Applicant: Sharp Kabushiki Kaisha, Osaka-shi (JP)

(72) Inventors: Satoshi Shibata, Osaka (JP); Tomoko Nango, Osaka (JP); Makoto Yamada, Osaka (JP); Yuka Utsumi, Osaka (JP)

(21) Appl. No.: 14/377,174

(22) PCT Filed: Feb. 1, 2013
(86) PCT No.: PCT/JP2013/052367

§ 371 Date: Aug. 6, 2014

(30) Foreign Application Priority Data
Feb. 7, 2012 (JP) 2012-024170

(51) Int. Cl. G02F 1/1335; F21V 9/08; G02F 1/1339

(52) U.S. Cl. CPC G02F 1/133617; G02F 1/133514; G02F 1/133553; G02F 1/1339; F21V 9/08
USPC 349/61; 362/84

(57) ABSTRACT

A display element includes: a light source; a phosphor layer configured to absorb light from the light source as excitation light and generate light in a wavelength region different from a wavelength region of the light source; a functional optical film configured to reflect the light emitted from the phosphor layer; and a light extraction structure having a function of emitting the light emitted from the phosphor layer to a non-light source, wherein the functional optical film is a band pass filter formed of a dielectric multilayer film, and a low refractive index layer is provided between the phosphor layer and the band pass filter, the low refractive index layer having a refractive index lower than those of the phosphor layer and a medium of band pass filter.

### TECHNICAL FIELD

The present invention relates to a display element, and an illumination device including this display element.

Priority is claimed on Japanese Patent Application No. 2012-024170, filed on Feb. 7, 2012, the content of which is incorporated herein by reference.

### BACKGROUND ART

There are display elements in which excitation light emitted from a light source is color-converted by a phosphor layer and emitted to an observer. As such display elements, a display element in which blue excitation light emitted from a backlight unit and modulated by a liquid crystal panel is color-converted by a red phosphor layer, a green phosphor layer and a blue color filter, and full-color display is performed, and a display element in which light from a light emitting layer arranged between a pair of electrodes is converted into a guided light wave component using a low refractive index layer and scattered by a nano structure layer, and light extraction to an observer is performed are known (Patent Document 1).

Further, for example, a display element in which a light reflection film is provided is known as a display element for enhancing efficiency of the light extraction to the observer (Patent Document 2). The light reflection film includes, for example, a silicon oxide film, a niobium oxide film, and a multilayer laminated film formed of a low refractive index material and a high refractive index material (e.g., a multilayer laminated film including a silicon oxide film and a niobium oxide film).

### PRIOR ART DOCUMENTS

### Patent Document

### [Patent Document 1] Japanese Unexamined Patent Application, First Publication No. 2005-251488

### [Patent Document 2] Japanese Unexamined Patent Application, First Publication No. 2009-134275

### SUMMARY OF INVENTION

### Problem to Be Solved by the Invention

The display element using color conversion of the phosphor layer has a problem in that, since the phosphor layer emits light isotropically within the display element, there is a light component that is confined due to a light guiding effect by total reflection and particularly, extraction to the observer of light emitted in a back direction of the observer side is difficult and not efficiently used as display light.

The present invention has been made in view of the circumstances described above, and an object of the present invention is to provide a display element and an illumination device in which light emitted isotropically from a phosphor layer can be efficiently extracted.

### Means to Solve the Problem

To solve the technical problem, a display element according to one embodiment of the present invention includes:

a light source;

a phosphor layer configured to absorb light from the light source as excitation light and generate light in a wavelength region different from a wavelength region of the light source;

a functional optical film configured to reflect the light emitted from the phosphor layer; and

a light extraction structure having a function of emitting the light emitted from the phosphor layer to a non-light source,

wherein the functional optical film is a band pass filter formed of a dielectric multilayer film, and a low refractive index layer is provided between the phosphor layer and the band pass filter.

The light source may have at least one maximum value in a range of wavelengths from 400 nm to 490 nm in an emission spectrum, and

the functional optical film may be a band pass filter including a dielectric multilayer film, having a region showing maximum transmittance in the range of wavelengths from 400 nm to 490 nm within a transmission spectrum and having a reflection band in a region of longer wavelengths than a wavelength of 490 nm.

The low refractive index layer may be an air layer.

The low refractive index layer may be a resin layer.

In addition, a display element according to one embodiment of the present invention includes:

a light source;

a light control element configured to control an amount of light from the light source;

a phosphor layer configured to absorb the light transmitted through the light control element as excitation light, and generate light in a wavelength region different from a wavelength region of the light source;

a functional optical film configured to reflect the light emitted from the phosphor layer; and

a light extraction structure having a function of emitting the light emitted from the phosphor layer to a non-light source,

wherein the light source has at least one maximum value in a range of wavelengths from 400 nm to 490 nm within an emission spectrum, and the light control element is a liquid crystal element interposed between a pair of polarization plates, and

the functional optical film is a band pass filter including a dielectric multilayer film, having a region showing maximum transmittance in the range of wavelengths from 400 nm to 490 nm within a transmission spectrum, and having a reflection band in a region of longer wavelengths than a wavelength of 490 nm.

The light extraction structure may protrudes to one surface of the phosphor layer and comes in contact with one surface of the band pass filter, and the low refractive index layer arranged between the phosphor layer and the band pass filter may be sealed in a periphery.

The light extraction structure may protrude to one surface of the phosphor layer and comes in contact with one surface of the band pass filter, and the low refractive index layer arranged between the phosphor layer and the band pass filter may include an opening in a periphery.

The light extraction structure may include an adhesive layer protruding to the one surface of the phosphor layer and comes in contact with one surface of the band pass filter, and the low refractive index layer arranged between the phosphor layer and the band pass filter may be sealed in a periphery.

The low refractive index layer and the band pass filter may be interposed between the one surface of the first substrate on which the phosphor layer is formed and one surface of the second substrate supporting the light control element, and the surfaces are bonded with a sealing material.

The low refractive index layer and the band pass filter may be interposed between one surface of the first substrate on which the phosphor layer is formed and one surface of the second substrate supporting the light control element, the surfaces may be bonded with a sealing material, and a periphery of the phosphor layer and a periphery of the band pass filter may have a gap with the sealing material.

The phosphor layer, the low refractive index layer and the band pass filter may be interposed and arranged between one surface on the light source side of the substrate on the non-light source side of the light control element interposed and arranged between a pair of substrates and a polarization plate on the non-light source side of the light control element.

The phosphor layer, the low refractive index layer and the band pass filter may be interposed and arranged between one surface on the light source side of the substrate on the non-light source side of the light control element interposed and arranged between a pair of substrates and a polarization plate on the non-light source side of the light control element, and

one surface of the substrate on the non-light source side on which the phosphor layer is formed and one surface of the substrate on the light source supporting the light control element may be adhered with a sealing material.

The phosphor layer, the low refractive index layer and the band pass filter may be interposed and arranged between one surface on the light source side of the substrate on the non-light source side of the light control element interposed and arranged between a pair of substrates and a polarization plate on the non-light source side of the light control element,

one surface of the substrate on the non-light source side on which the phosphor layer is formed and one surface of the substrate on the light source supporting the light control element may be adhered with a sealing material, and

a periphery of the phosphor layer and a periphery of the band pass filter may have a gap with the sealing material.

In the band pass filter, a short wavelength end of a reflection band may be a short wavelength side compared to a wavelength of 490 nm for incident light at an incident angle 0° from the low refractive index layer, and a long wave length side of the refraction band may be a long wavelength side compared to a wavelength of 750 nm for the incident light at a maximum incident angle from the low refractive index layer. It is preferable that the long wavelength end of the refraction band is at long wavelength side compared to 1000 nm.

In addition, a display element according to one embodiment of the present invention includes:

a light source;

a light control element configured to control an amount of light from the light source;

a phosphor layer configured to absorb the light transmitted through the light control element as excitation light, and generate light in a wavelength region different from a wavelength region of the light source;

a functional optical film configured to reflect the light emitted from the phosphor layer; and

a light extraction structure having a function of emitting the light emitted from the phosphor layer to a non-light source,

wherein the functional optical film is a band pass filter including a dielectric multilayer film, having a region showing maximum transmittance in the range of wavelengths from 400 nm to 490 nm within a transmission spectrum and having a reflection band in a region of longer wavelengths than a wavelength of 490 nm, and

the light control element includes an MEMS.

In addition, a display element according to one embodiment of the present invention includes:

a light source;

a light control element configured to control an amount of light from the light source;

a phosphor layer configured to absorb the light transmitted through the light control element as excitation light, and generate light in a wavelength region different from a wavelength region of the light source;

a functional optical film configured to reflect the light emitted from the phosphor layer; and

a light extraction structure having a function of emitting the light emitted from the phosphor layer to a non-light source,

wherein the functional optical film is a band pass filter including a dielectric multilayer film, having a region showing maximum transmittance in the range of wavelengths from 400 nm to 490 nm within a transmission spectrum, and having a reflection band in a region of longer wavelengths than a wavelength of 490 nm, and

the light source and the light control element are blue light emitting EL elements.

The band pass filter may be a dielectric multilayer film using an organic film.

The band pass filter may include the low refractive index layer and the dielectric multilayer film that are formed integrally,

the low refractive index layer has a refractive index lower than any of a high refractive index layer and a low refractive index layer constituting the dielectric multilayer film, and

a film thickness of the low refractive index layer is greater than a wavelength of a visible light region.

An illumination device according to one embodiment of the present invention includes one of the above-described display elements.

### EFFECT OF THE INVENTION

According to the present invention, it is possible to provide a display element and an illumination device in which light emitted isotropically from the phosphor layer can be efficiently extracted to an observer.

### BRIEF DESCRIPTION OF DRAWINGS

FIG. 1 is a schematic cross-sectional view illustrating a display element of a first embodiment of the present invention.

FIG. 2 is a schematic cross-sectional view illustrating primary portions of the display element of the first embodiment of the present invention.

FIG. 3A is a diagram illustrating reflectance due to an incident angle at each wavelength of incident light.

FIG. 3B is a diagram illustrating incidence angle dependence of a reflection characteristic of a band pass filter according to the embodiment of the present invention.

FIG. 4 is a schematic view illustrating reflection of excitation light in the first embodiment of the present invention.

FIG. 5A is a schematic cross-sectional view illustrating a bonding method for the display element of the first embodiment of the present invention.

FIG. 5B is a schematic cross-sectional view illustrating a bonded configuration of the primary portions of the display element of the first embodiment of the present invention.

FIG. 6A is a schematic view illustrating a peripheral sealing portion of the display element of the first embodiment of the present invention.

FIG. 6B is a schematic enlarged view of the peripheral sealing portion of the display element of the first embodiment of the present invention.

FIG. 6C is a schematic view illustrating a peripheral sealing portion of the display element of the first embodiment of the present invention.

FIG. 7 is a schematic cross-sectional view illustrating a variant of the display element of the first embodiment of the present invention.

FIG. 8A is a schematic cross-sectional view illustrating a method of bonding primary portions of a display element of a second embodiment of the present invention.

FIG. 8B is a schematic cross-sectional view illustrating a bonded configuration of the primary portions of the display element of the second embodiment of the present invention.

FIG. 9 is a schematic cross-sectional view illustrating a display element of a third embodiment of the present invention.

FIG. 10 is a schematic cross-sectional view illustrating a display element of a fourth embodiment of the present invention.

FIG. 11 is a schematic cross-sectional view illustrating a display element of a fifth embodiment of the present invention.

FIG. 12 is a schematic cross-sectional view of a blue light emitting EL element that is an example of an optical modulation portion.

FIG. 13 is a schematic cross-sectional view illustrating a display element of a comparative example.

FIG. 14A is a graph showing dependence of an angle of incidence on the band pass filter of a reflection spectrum.

FIG. 14B is a graph showing dependence of an angle of incidence on the band pass filter of a reflection spectrum.

FIG. 15 is a schematic cross-sectional view illustrating a display element of a variant of the third embodiment of the present invention.

FIG. 16A is a schematic cross-sectional view illustrating an example of the illumination device of the present invention.

FIG. 16B is a schematic cross-sectional view illustrating an example of the illumination device of the present invention.

### EMBODIMENT FOR CARRYING OUT THE INVENTION

While the present invention will be described in connection with embodiments and examples in greater detail with reference to the drawings, the present invention is not limited to these embodiments and examples.

In addition, it should be noted that, in a description using the following drawings, the drawings are schematic and a ratio or the like of each dimension is different from a real one. Illustration of members other than members necessary for ease of understanding is appropriately omitted. In addition, refraction at an interface with a different refractive index is omitted in the drawings illustrated in each of the following embodiments, and only behavior of the transmission or reflection is illustrated.

### First Embodiment

(1) Entire Configuration of a Display Element

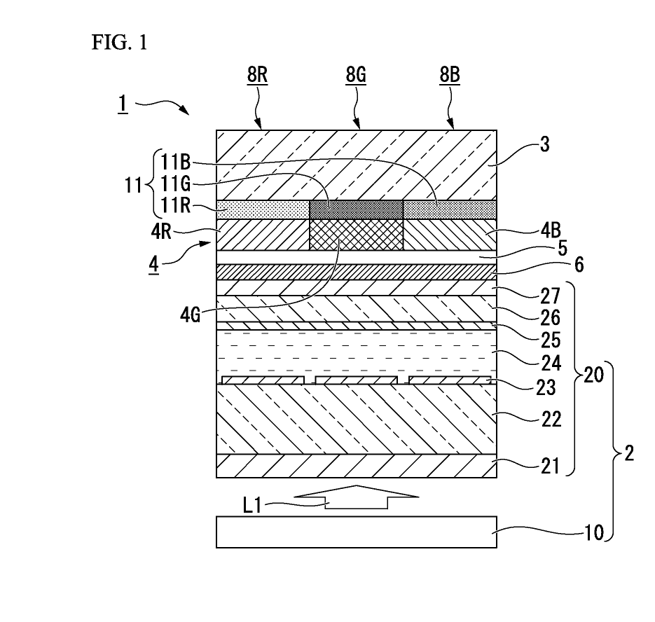

Hereinafter, a first embodiment will be described using FIGS. 1 to 7 and 13. FIG. 1 is a schematic cross-sectional view illustrating a display element of this embodiment, and FIG. 13 is a schematic cross-sectional view illustrating a display element of a comparative example.

The display element 1 of this embodiment includes an optical modulation portion 2, a substrate 3 arranged opposite to the optical modulation portion 2, a phosphor layer 4 arranged on the optical modulation portion 2 side of the substrate 3, a color filter layer 11 arranged between the substrate 3 and the phosphor layer 4, and a band pass filter 6 arranged with a low refractive index layer 5 interposed between the optical modulation portion 2 and the phosphor layer 4, as illustrated in FIG. 1. In the display element 1 of this embodiment, a red subpixel 8R that performs display by red light, a green subpixel 8G that performs display by green light, and a blue subpixel 8B that performs display by blue light are arranged to be adjacent. The three subpixels 8R, 8G and 8B constitute one pixel that is a minimum unit constituting a display.

The optical modulation portion 2 includes a backlight (light source) 10 and a liquid crystal panel 20 (liquid crystal element). In this embodiment, an optical modulation element includes the liquid crystal panel 20 that can adjust optical transmittance in each predetermined region through application of a voltage.

(1.1) Configuration of the Backlight

The backlight 10 emits excitation light L1 for exciting the phosphor layers 4R, 4G and 4B. In this embodiment, the backlight 10 emits ultraviolet light or blue light as the excitation light L1. A backlight having at least one maximum value in a range of wavelengths from 350 nm to 470 nm in an emission spectrum, that is, a backlight showing maximum intensity in the range of wavelengths from 350 nm to 470 nm, is used as the backlight 10. Preferably, a backlight showing maximum intensity in the range of wavelengths from 430 nm to 470 nm is used. For example, a blue light emitting diode (blue LED) having a maximum value around a wavelength of 450 nm is used as the backlight 10.

(1.2) Configuration of the Liquid Crystal Panel

The liquid crystal panel 20 modulates transmittance of the excitation light L1 emitted from the backlight 10 for each of the subpixels 8R, 8G and 8B described above. The excitation light L1 modulated by the liquid crystal panel 20 is incident on the phosphor layers 4R, 4G and 4B. Accordingly, light emitted through excitation of the phosphor layers 4R, 4G and 4B is emitted to the outside. Therefore, in this embodiment, an upper side of the display element 1 illustrated in FIG. 1 is a viewing side from which an observer views the display.

The liquid crystal panel 20 includes a first polarization plate 21, a first substrate 22, a liquid crystal layer 24 interposed between a pair of transparent electrodes 23 and 25, a second substrate 26, and a second polarization plate 27, and has a structure in which these are laminated sequentially from the backlight 10 side. In addition, a configuration in which the second substrate 26 is not included may be adopted as the liquid crystal panel. In this case, a polarization plate having a sheet shape (a polarization layer) is used as the second polarization plate 27 instead of a polarization plate having a plate shape.

The first transparent electrode 23 is formed on an inner surface (a surface on the liquid crystal layer 24 side) of the first substrate 22 for each subpixel, and an orientation film (not illustrated) is formed to cover the first transparent electrode 23. The first polarization plate 21 is provided on an external surface (a surface opposite to the liquid crystal layer 24 side) of the first substrate 22. A substrate formed of glass, quartz, plastic or the like that is able to transmit the excitation light, for example, may be used as the first substrate 22. A transparent conductive material such as indium tin oxide (hereinafter abbreviated as ITO), for example, is used for the first transparent electrode 23.

A general polarization plate used for a conventional liquid crystal display element may be used for the first polarization plate 21.

On the other hand, the second transparent electrode 25 and an orientation film (not illustrated) are laminated on an inner surface (a surface on the liquid crystal layer 24 side) of the second substrate 26. The second polarization plate 27 is provided on an outer surface (a surface opposite to the liquid crystal layer 24 side) of the second substrate 26. A substrate formed of glass, quartz, plastic or the like that is able to transmit the excitation light may be used for the second substrate 26, like the first substrate 22. A transparent conductive material such as ITO is used for the second transparent electrode 25, like the first transparent electrode 23.

A system for the liquid crystal panel 20 is not particularly limited and, for example, an active matrix system in which a switching element such as a thin film transistor (hereinafter abbreviated as TFT) is included for each subpixel may be adopted or a passive matrix system in which no TFT is included may be adopted. In addition, a mode of the liquid crystal layer 24 is not particularly limited, and various liquid crystal modes such as a TN (Twisted Nematic) mode, a VA (Vertical Alignment) mode, and an IPS (In-Plane Switching) mode may be adopted.

(1.3) Configuration on the Inner Surface Side of the Substrate

A color filter layer 11, a phosphor layer 4, a low refractive index layer 5, and a band pass filter 6 are laminated on an inner surface (a surface on the backlight 10 side) of the substrate 3 in this order from the substrate 3 side.

The color filter layer 11 includes a color filter layer 11R that transmits red light, a color filter layer 11G that transmits green light, and a color filter layer 11B that transmits blue light. The color filter layer 11R transmitting the red light is arranged on the phosphor layer 4R emitting the red light. The color filter layer 11G transmitting the green light is arranged on the phosphor layer 4G emitting the green light. The color filter layer 11 B transmitting the blue light is arranged on a light diffusion layer that diffuses the blue light from the phosphor layer 4B emitting the blue light or the backlight 10.

In addition, a light transmission spectrum of the color filter layer 11 in each of RGB areas can be appropriately designed in consideration of correction of color purity and a function as an external light absorption filter. In addition, the color filter layer functions as an external light cut filter. When external light is directly incident on the phosphor layer, the phosphor is excited, generating an unnecessary emitted light component and causing contrast degradation. Accordingly, the external light can be cut by the color filter layer to prevent the contrast degradation.

A phosphor material constituting the phosphor layer 4 has a different emission wavelength band for each subpixel.

When the excitation light from the backlight 10 is ultraviolet light, the phosphor layer 4R formed of a phosphor material that absorbs the ultraviolet light and emits the red light is provided in the red subpixel 8R, the phosphor layer 4G formed of a phosphor material that absorbs the ultraviolet light and emits the green light is provided in the green subpixel 8G, and the phosphor layer 4B formed of a phosphor material that absorbs the ultraviolet light and emits the blue light is provided in the blue subpixel 8B.

Or, when the excitation light from the backlight 10 is blue light, phosphor layers formed of phosphor materials that absorb the blue light and emit the red light and the green light are provided in the red subpixel 8R and the green subpixel 8G, respectively, and a light diffusion layer that diffuses the blue light that is excitation light without wavelength-converting the blue light and emits the blue light to the outside is provided in the blue subpixel 8B in place of the phosphor layer.

The phosphor layer 4 may be formed of only a phosphor material to be illustrated below, may optionally contain an additive, or may have a configuration in which such a phosphor material is dispersed in a binding material, such as a resin material or an inorganic material. A known phosphor material may be used as the phosphor material of this embodiment. This kind of phosphor material may be classified as an organic phosphor material or an inorganic phosphor material. While specific compounds of these will be illustrated below, the present embodiment is not limited to these materials.

For the organic phosphor material, fluorescent materials for converting ultraviolet light or blue light into green light may include, for example, a coumarin-based dye: 2,3,5,6-1H,4H-tetrahydro-8-trifluomethylquinolizine(9,9a,1-gh)coumarin (coumarin 153), 3-(2′-benzothiazolyl)-7-diethylaminocoumarin (coumarin 6), 3-(2′-benzimidazolyl)-7-N, and N-diethylaminocoumarin (coumarin 7), and a naphthalimide-based dye: basic yellow 51, solvent yellow 11, and solvent yellow 116. In addition, fluorescent materials for converting ultraviolet light or blue light into red light may include, for example, a cyanine-based dye:

4-dicyanomethylene-2-methyl-6-(p-dimethylaminostyryl)-4H-pyran, a pyridine-based dye: 1-ethyl-2-[4-(p-dimethylaminophenyl)-1,3-butadienyl]-pyridinium-perchlorate, and a rhodamine-based dye: rhodamine B, rhodamine 6G, rhodamine 3B, rhodamine 101, rhodamine 110, basic violet 11, and sulforhodamine 101.

For the inorganic phosphor material, fluorescent materials for converting ultraviolet light or blue light into green light may include, for example, (BaMg)Al₁₆O₂₇:Eu²⁺, Mn²⁺, Sr₄Al₁₄O₂₅:Eu²⁺, (SrBa)Al₁₂Si₂O₈:Eu²⁺, (BaMg)₂SiO₄:Eu²⁺, Y₂SiO₅:Ce³⁺, Tb³⁺, Sr₂P₂O₇-Sr₂B₂O₅:Eu²⁺, (BaCaMg)₅(PO₄)₃Cl:Eu²⁺, Sr₂Si₃O₈-2 SrCl₂:Eu²⁺, Zr₂SiO₄, MgAl₁₁O₁₉:Ce³⁺, Tb³⁺, Ba₂SiO₄:Eu²⁺, Sr₂SiO₄:Eu²⁺, and (BaSr)SiO₄:Eu²⁺.

Further, fluorescent materials for converting ultraviolet light or blue light into red light may include, for example, Y₂O₂S:Eu³⁺, YAlO₃:Eu³⁺, Ca₂Y₂(SiO₄)₆:Eu³⁺, LiY₉(SiO₄)₆O₂:Eu³⁺, YVO₄:Eu³⁺, CaS:Eu³⁺, Gd₂O₃:Eu³⁺, Gd₂O₂S:Eu³⁺, Y(P,V)O₄:Eu³⁺, Mg₄GeO₅₅F:Mn⁴⁺, Mg₄Geo₆:Mn⁴⁺, K₅Eu₂₅(WO₄)_{6.25}, Na₅Eu_{2 5}(WO₄)_{6.25}, K₅Eu_{2.5}(MoO₄)_{6.25}, and Na₅Eu_{2 5}(MoO₄)_{6.25}.

Further, micronization of a semiconductor material such as CdSe, ZnSe, InP or S1 to a nanosize for fluorescent emission is known. Visible light is emitted with a size of about 2 nm to about 8 nm, but an emission wavelength is shorter as a particle size is smaller.

The phosphor layer 4 can be formed through a known wet process by a coating method such as a spin coating method, a dipping method, a doctor blade method or a spray coat method, or a printing method such as an ink-jet method, a relief printing method, an intaglio printing method, or a screen printing method using a solution in which the phosphor material and the resin material are dissolved or dispersed in a solvent; a known dry process such as a resistance heating deposition method, an electron beam (EB) deposition method, a molecular beam epitaxy (MBE) method, a sputtering method, or an organic vapor phase deposition (OVPD) method using the above material; or a laser transfer method.

Further, the phosphor layer 4 may be patterned by a photolithography method using a photosensitive resin as the above resin material. For the photosensitive resin, one kind or a mixture of a plurality of kinds of photosensitive resins (photo-curable resist materials) having a reactive vinyl group, such as an acrylic-acid-based resin, a methacrylic-acid-based resin, or a hard rubber-based resin. In addition, the phosphor material may also be directly patterned using a wet process such as the ink jet method, the relief printing method, the intaglio printing method, or the screen printing method described above; the known dry process such as the resistance heating deposition method, the electron beam (EB) deposition method, the molecular beam epitaxy (MBE) method, the sputtering method, or the organic vapor phase deposition (OVPD) method using a mask; or the laser transfer method.

The low refractive index layer 5 is arranged between the phosphor layer 4 and the band pass filter 6. The low refractive index layer 5 is formed as a layer having a refractive index lower than that of either the phosphor layer or the band pass filter layer. Specifically, for example, when a refractive index of the phosphor layer 4 is 1.58 and a refractive index of the band pass filter 6 is 1.59, an air layer having a refractive index of 1.0 may be used as the low refractive index layer 5.

The band pass filter 6 has a structure of a dielectric multilayer film or the like, and reflects, to the observer, light emitted to the backlight 10 of a light component fluorescently emitted within the phosphor layer 4. Particularly, the function of the band pass filter 6 will be described below. For light at an incidence angle 0°, that is, light incident in parallel to a panel normal direction from the backlight 10, the band pass filter 6 transmits the light in the blue region and reflects light ranging from a green region to a near-infrared region.

Therefore, for example, there is a characteristic that the blue light having high directivity from the backlight 10 is transmitted at high transmittance, and the light color-converted and emitted isotropically within the phosphor layer 4 is reflected at high reflectance.

In addition, it is preferable for the band pass filter 6 to have such a thickness that optical crosstalk exciting a phosphor installed in a neighboring pixel region does not occur until the light transmitted through the second polarization plate 27 is incident on the phosphor layer 4. Specifically, it is preferable for the thickness of the band pass filter 6 to be smaller than a distance between pixels.

(2) Operation and Effects of the Display Element

Next, operation of the first embodiment in which the low refractive index layer 5 is arranged between the phosphor layer 4 and the band pass filter 6 will be described with reference to FIGS. 1 to 4. However, problems of a display element of a comparative example will first be described with reference to a drawing.

In addition, the same components as those in the drawings used in the first embodiment are denoted with the same reference signs in the description of the comparative example, and a detailed description thereof is omitted.

FIG. 13 is a schematic cross-sectional view illustrating primary portions of a display element 100 of the comparative example. In the display element 100, a first polarization plate 21, a first substrate 22, a liquid crystal layer 24, a second substrate 26, a second polarization plate 27, a band pass filter 6, a phosphor layer 4, a color filter layer 11, and a substrate 3 are laminated in this order from a backlight 10 (see FIG. 1) side. The phosphor layer 4 and the band pass filter 6 are bonded without a low refractive index layer interposed therebetween. A resin having substantially the same refractive index as those of the phosphor layer 4 and the band pass filter 6 is used for bonding.

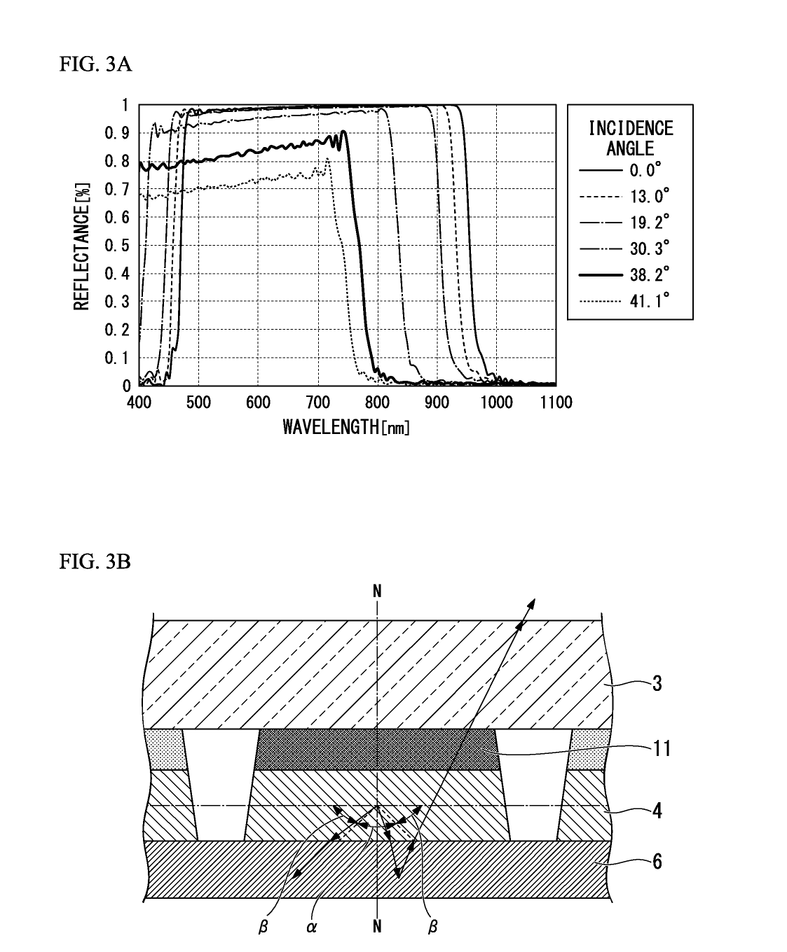

Next, an incidence angle dependence of a reflection characteristic of the band pass filter 6 will be described with reference to FIGS. 3A and 3B. FIG. 3A shows reflectance due to an incident angle for each wavelength of incident light, in which a horizontal axis indicates the wavelength, and a vertical axis indicates the reflectance. Respective incidence angles (0.0°, 13.0°, 19.2°, 30.3°, 38.2° and 41.1°) indicate angles within a medium constituting the band pass filter 6.

For the light at an incidence angle of 0.0°, reflectance of the blue light source indicating a maximum light amount in a blue region, that is, in a range of wavelengths from 410 nm to 480 nm, is about 0%, and the light in this region is transmitted. For example, a maximum light amount wavelength of the backlight including a blue LED in the light source is 455 nm, and the light is transmitted by the band pass filter 6.

On the other hand, when the incidence angle is 0°, light ranging from a green region to a near-infrared region, that is, a region of wavelengths from 500 nm to 1000 nm, is reflected by about 100%, but a reflection spectrum shifts to a short wavelength side as the incidence angle increases. For example, if the incidence angle is 41.1°, light in a region of longer wavelengths than a wavelength of 700 nm is hard to reflect (see FIG. 3A).

In other words, the band pass filter 6 has a characteristic that the band pass filter 6 transmits the blue light having high directivity from the backlight 10 at high transmittance and reflects the light color-converted and emitted isotropically within the phosphor layer at high reflectance. Such a characteristic of the band pass filter 6 is called a blue shift characteristic in the following description.

FIG. 3B schematically illustrates a reflection characteristic according to an angle of incidence on the band pass filter 6 of the light excited in the phosphor layer.

The light color-converted in the phosphor layer 4 and incident on the band pass filter 6 is isotropic, and an incidence angle thereof ranges from 0° to a maximum of 90°. However, a light component at an incidence angle α less than ±42° with respect to a panel normal N-N is reflected in the band pass filter 6 and reflected from the substrate 3 to the outside, that is, toward an observer, due to the blue shift characteristic of the band pass filter. On the other hand, a light component incident on the band pass filter 6 at an incidence angle β exceeding ±142° with respect to the panel normal N-N, which is a light component in a long wavelength region, i.e., a red region, cannot be reflected to the observer (see FIG. 3B).

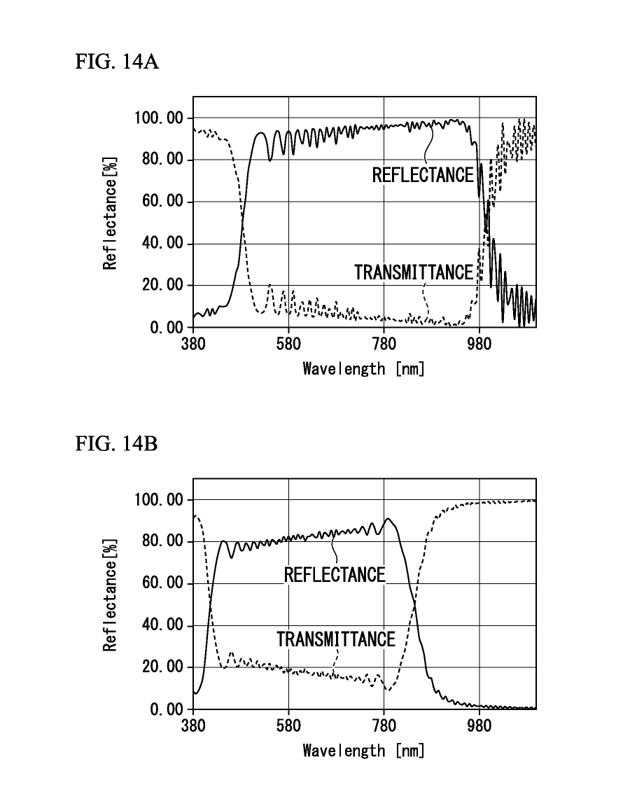

Dependence of an angle of incidence on the band pass filter 6 of the reflection spectrum is illustrated in FIGS. 14A and 14B.

FIG. 14A is a graph showing a relationship between transmittance and reflectance, and an incidence wavelength when an angle of incidence on the band pass filter 6 is 0°, i.e., at the time of normal incidence. Further, FIG. 14B is a graph showing a relationship between transmittance and reflectance, and an incidence wavelength when an angle of incidence on the band pass filter 6 is 39°, i.e., a maximum incidence angle. According to these graphs, when an angle of the light incident on the band pass filter 6 is inclined from a vertical direction to a horizontal direction, decrease in transmittance and increase in reflectance on the long wavelength side shift to a short wavelength. In addition, it is seen that increase in transmittance and decrease in reflectance occur in a central wavelength region.

When the band pass filter 6 is formed of a dielectric multilayer film, influence of the blue shift characteristic is strong, as described above. Accordingly, in order to reflect an entire visible light region in the light in the range of all incidence angles, i.e., 0° to 90°, it is necessary for the light at all the incidence angles to satisfy a condition of 2ndsinθ=mλ when the incidence angle is θ, a refractive index of the dielectric multilayer film is n, and a film thickness of one layer of a repetition unit of the high refractive index layer and the low refractive index layer is d.

For example, when light at a wavelength of 650 nm is incident on the band pass filter 6 and this light is reflected, the light can be reflected when the film thickness of one layer of the dielectric multilayer film is about 205 nm at the incidence angle of 0°. On the other hand, it is necessary for the one layer of the dielectric multilayer film to have a film thickness of 411 nm at the incidence angle of 60° and a film thickness of 1184 nm at the incidence angle of 80°. The dielectric multilayer film may include tens of layers to 100 layers or more and the layer thickness of the band pass filter 6 becomes excessively great.

When the band pass filter 6 having such a layer thickness is arranged between the phosphor layer and the liquid crystal layer, optical crosstalk in which a phosphor installed in an adjacent pixel region is excited before the light transmitting the second polarization plate is incident on the phosphor layer occurs.

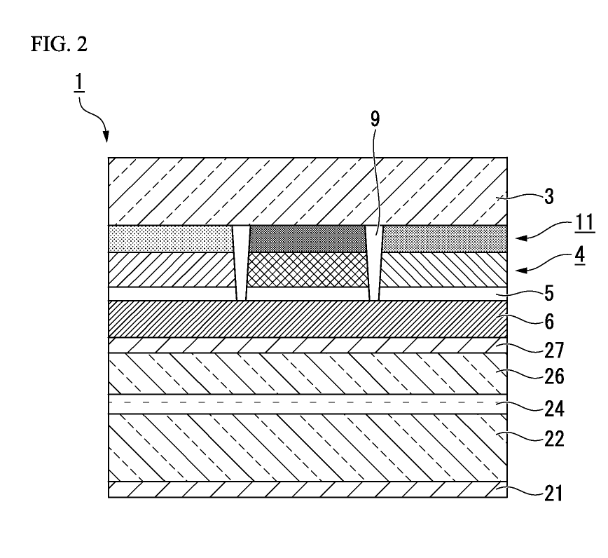

FIG. 2 is a schematic cross-sectional view illustrating primary portions of the first embodiment. The first polarization plate 21, the first substrate 22, the liquid crystal layer 24, the second substrate 26, the second polarization plate 27, the band pass filter 6, the low refractive index layer 5, the phosphor layer 4, the color filter layer 11, and the substrate 3 are laminated in this order from the backlight 10 (see FIG. 1) side. A light extraction structure 9 is arranged between the substrate 3 and the band pass filter 6 for each pixel. In other words, the display element 1 of the first embodiment is different from the display element 100 according to the comparative example in that the low refractive index layer 5 is arranged between the phosphor layer 4 and the band pass filter 6.

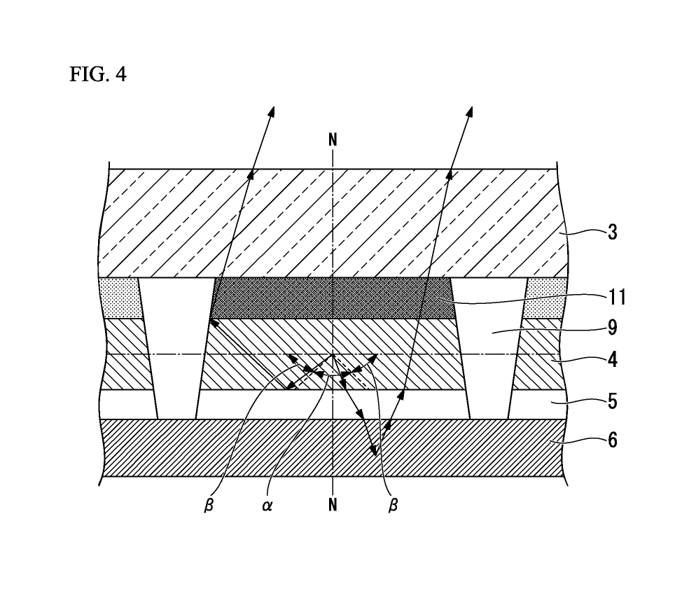

For example, a component at an incidence angle α smaller than +39° with respect to a panel normal N-N in the light on the backlight 10 side emitted isotropically within the phosphor layer 4 having a refractive index of 1.58 is transmitted through the low refractive index layer 5 and incident on the band pass filter 6, but since the blue shift characteristic is given to a reflection band of the band pass filter 6, light ranging from a green region to a red region is reflected by the band pass filter 6 and returned to the phosphor layer 4 again, as illustrated in FIG. 4. Since the light extraction structure 9 is arranged in the same layer of the phosphor layer 4, a light path of the light returned to the phosphor layer 4 may be changed due to the reflection and the light can be emitted to the outside, that is, the observer side.

On the other hand, when light of a component at an incidence angle β greater than ±39° with respect to a panel normal N-N is incident on the low refractive index layer 5, the light is totally reflected, scattered by the light extraction structure 9 or a scatterer in the color filter 11, and emitted to the outside, that is, the observer side. Therefore, according to the display element of this embodiment, it is possible to efficiently extract the excitation light emitted isotropically within the phosphor layer 4 toward the observer.

In addition, in the display element 1 of this embodiment, only the component at an incidence angle α smaller than ±39° with respect to a panel normal N-N in the light incident on the low refractive index layer 5 formed of an air layer (refractive index: 1.0) is incident on the band pass filter 6. Accordingly, the band pass filter 6 is formed of a functional optical film having a layer thickness at which the optical crosstalk does not occur, and specifically a total film thickness of about 100 μm, such that the band pass filter 6 capable of reflecting an entire wavelength region can be formed.

It is preferable for the reflection band of the band pass filter of this embodiment to be set to include an emission spectrum of a red phosphor and an emission spectrum of a green phosphor. When the blue shift of the band pass filter is considered, it is preferable for a reflection band for the light at a maximum incidence angle incident on the band pass filter to sufficiently include the emission spectrum of the red phosphor.

When a refractive index n of the medium is n, the incidence angle is θ, and a reflection wavelength at the incidence angle 0° is λ0, the blue shift of the band pass filter has a relationship of λ(θ)=λ0×cos(sin−1(sin(α)/n). Accordingly, it is necessary for a long wavelength end of the reflection band at the incidence angle 0° to be about 1000 nm in order for the long wavelength end of the reflection band of the band pass filter to include 750 nm that is a long wavelength end of the emission spectrum of the red phosphor when the incidence angle α is a maximum incidence angle 39° under the above conditions.

In addition, since the reflection band of the band pass filter as described above can be appropriately designed according to the refractive index of the material used and an emission spectrum of a light emitting body, the reflection band is not limited to the values described above.

(3) A Laminating Method for the Display Element

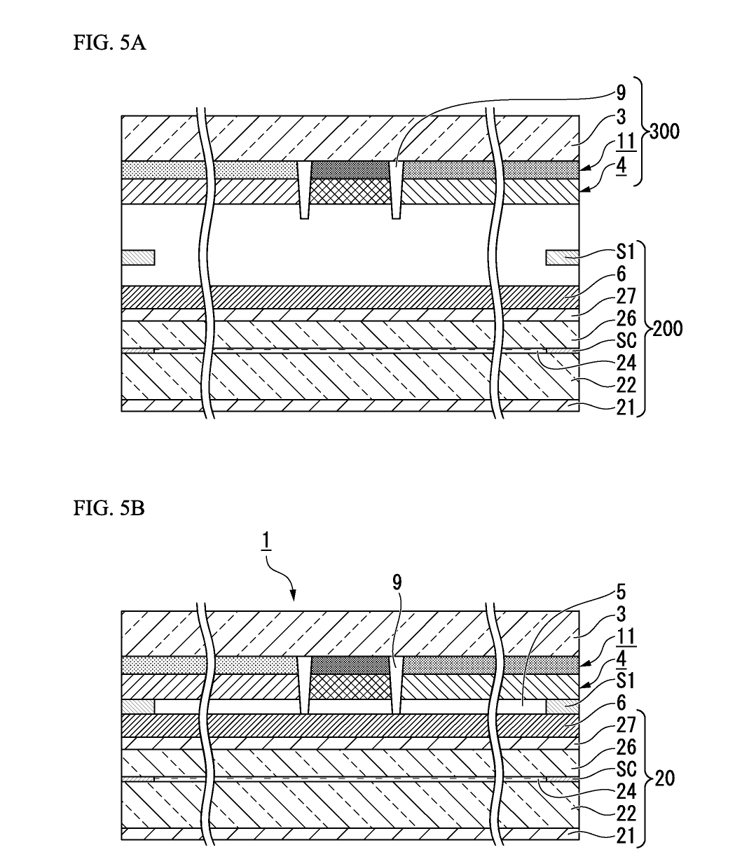

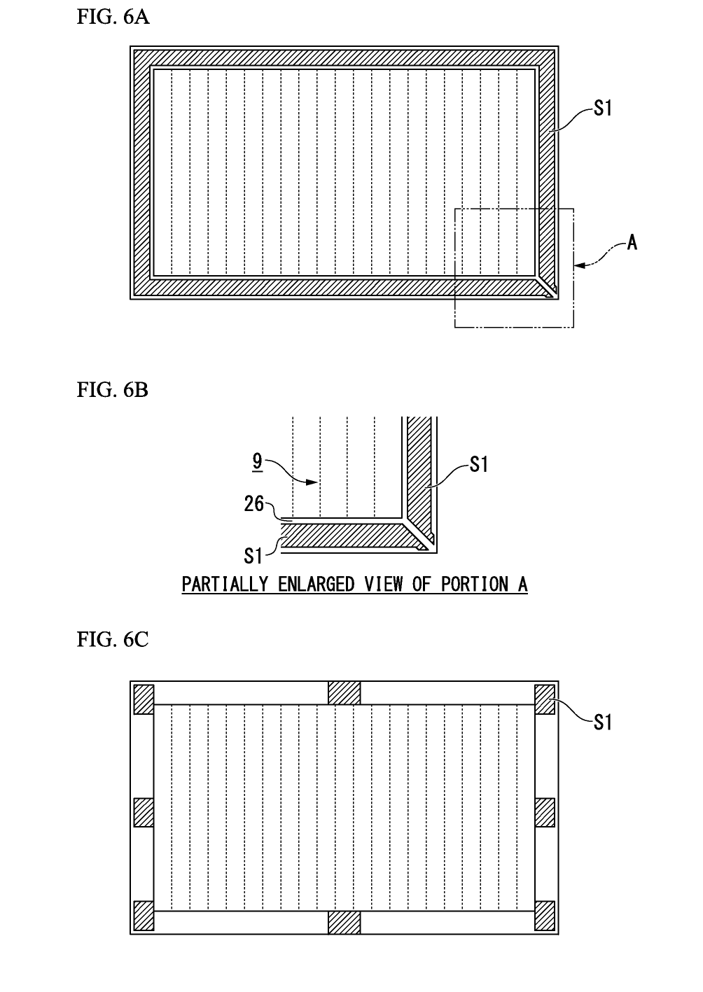

A bonding method for the display element 1 will be described with reference to FIGS. 5A to 6C.

FIG. 5A is a schematic cross-sectional view illustrating a method of bonding the primary portions of the display element 1 of this embodiment. FIG. 5B is a cross-sectional view illustrating a bonded configuration of the primary portions of the display element 1 of this embodiment.

A lower substrate 200 in which the liquid crystal panel 20 with the liquid crystal layer 24 interposed between the first substrate 22 including the first polarization plate 21 on the backlight 10 side and the second substrate 26 including the second polarization plate 27 on the observer side is used as a support, and the band pass filter 6 is formed on the observer side, and an upper substrate 300 in which the substrate 3 including the color filter layer 11 and the phosphor layer 4 formed thereon is used as a support are bonded through an air layer. In addition, the air layer may be an inert gas such as dry air, nitrogen and argon, as well as atmospheric air (see FIG. 5A).

The light extraction structure 9 for defining the subpixels 8R, 8G and 8B as regions is formed in the upper substrate 300. The light extraction structure 9 is a structure formed of a white scatterer such as a resin in which titanium oxide is dispersed, and diffusively reflects a part of light emitted by the phosphor layer 4 to increase efficiency of light extraction toward the observer. In addition, the light extraction structure 9 may be a reflective material in which fine metal particles are dispersed or may be a reflective material on a surface of which a metal film is deposited.

The light extraction structure 9 is formed to protrude at least 1 μm or more from the band pass filter 6 side of the phosphor layer 4. When the upper substrate 300 is bonded to the lower substrate 200, the protruding portion of the light extraction structure 9 functions as a spacer for maintaining a constant gap between the substrates and holding the low refractive index layer 5 (an air layer) therein.

A schematic cross-sectional view of the primary portions of the display element of this embodiment bonded using such a method is illustrated in FIG. 5B.

It is necessary to pattern the light extraction structure 9 before forming the color filter layer 11 and the phosphor layer 4. Therefore, it may be difficult to give an adhesive property to the light extraction structure 9 from the viewpoint of production efficiency, and adhesion to a peripheral portion of the display area may be performed using, for example, a peripheral sealing material S1 such as an epoxy based adhesive or an acrylic based adhesive.

The peripheral sealing material S1 may be provided continuously in the outer peripheral portion of the panel as illustrated in FIG. 6A, but there is a possibility of a change in volume of the air layer being caused and the sealing portion causing peeling due to change in atmospheric pressure or temperature when the upper substrate 300 and the lower substrate 200 are bonded as a complete sealing structure. Therefore, it is preferable to provide an opening as a vent in a portion of the peripheral sealing material S1 (see FIG. 6B).

In addition, the peripheral sealing material S1 may be appropriately selectively provided in corner portions or portions of respective sides of the outer periphery of the panel, as illustrated in FIG. 6C.

In this embodiment, the light extraction structure 9 can uniformly hold a gap of the low refractive index layer 5 since the light extraction structure 9 is arranged in each pixel and has a function of a spacer between the phosphor layer 4 and the band pass filter 6.

(4) Variant

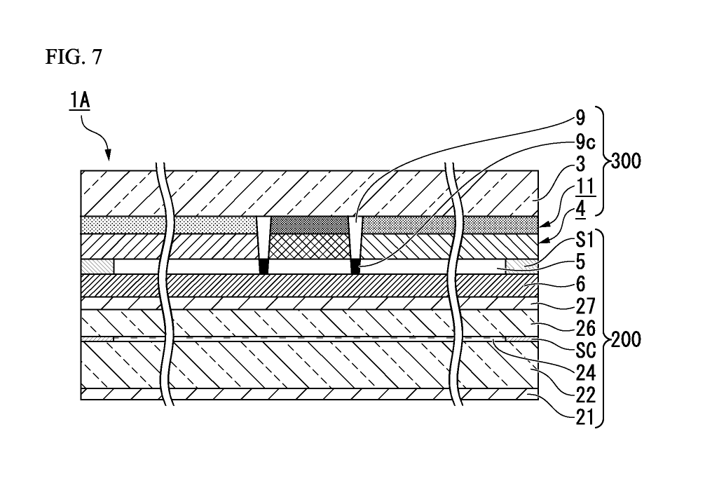

A variant of the display element according to this embodiment is illustrated in FIG. 7. The display element 1A of this variant is formed in such a manner that the protruding portion of the light extraction structure 9 has an adhesive layer 9c. The upper substrate 300 including such a light extraction structure 9 is directly bonded to the lower substrate 200 through the light extraction structure 9, such that the gap of the low refractive index layer 5 can be uniformly held.

In addition, the substrates may be bonded by additionally using the peripheral sealing material S1 for the purpose of further improving adhesive strength. Further, such a peripheral sealing material S1 may be provided continuously in the outer peripheral portion of the panel or may be provided appropriately selectively in corner portions or portions of respective sides of the panel periphery (see FIGS. 6A to 6C).

### Second Embodiment

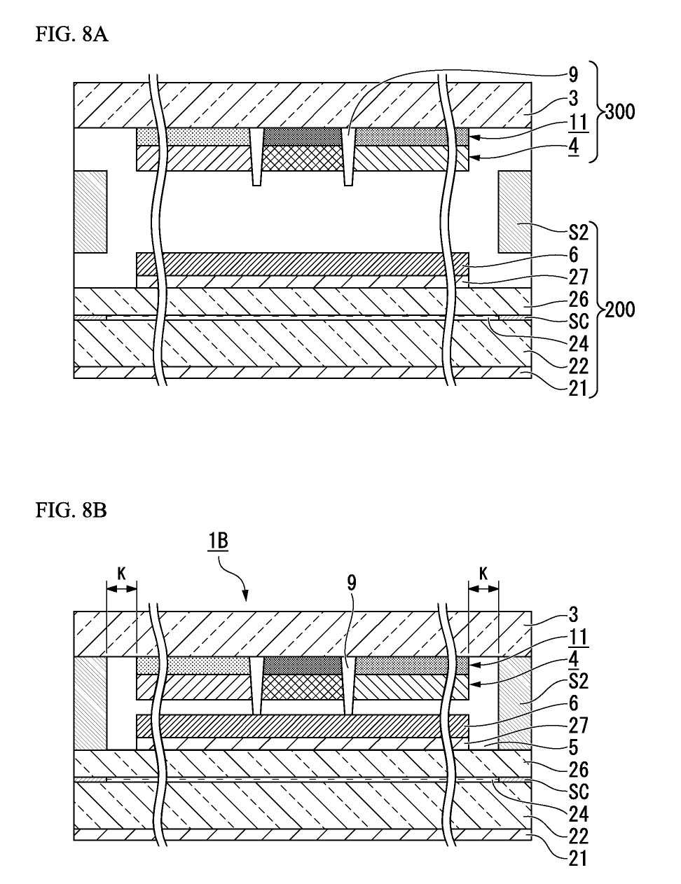

Hereinafter, a display element 1B of a second embodiment of the present invention will be described using FIGS. 8A and 8B.

A basic configuration of the display element 1B of this embodiment is the same as that of the display element 1 of the first embodiment, and the second embodiment is different from the first embodiment in that glass surfaces of an upper substrate 300 and a lower substrate 200 are directly bonded by a peripheral sealing material S2.

FIG. 8A is a schematic cross-sectional view illustrating a method of bonding primary portions of the display element 1B of this embodiment. FIG. 8B is a cross-sectional view illustrating a bonded configuration of the primary portions of the display element 1B of this embodiment. The same components in FIGS. 8A and 8B as those in FIG. 1 of the first embodiment are denoted with the same reference signs and a detailed description thereof is omitted.

(1) Configuration of the Display Element

In the display element 1B of the second embodiment, a first polarization plate 21, a first substrate 22, a liquid crystal layer 24, a second substrate 26, a second polarization plate 27, a band pass filter 6, a low refractive index layer 5, a phosphor layer 4, a color filter layer 11, and a substrate 3 are laminated in this order from the backlight 10 (see FIG. 1) side.

A light extraction structure 9, the color filter layer 11, and the phosphor layer 4 are formed on the substrate 3. The first substrate 21 and the second substrate 26 are bonded with the liquid crystal layer 24 interposed therebetween.

The polarization plate 27 and the band pass filter 6 are arranged on one surface on the observer side of the second substrate 26 through a bonding layer (adhesive layer), and the substrate 3 on which the light extraction structure 9, the color filter layer 11, and the phosphor layer 4 are formed is bonded through an air layer as the low refractive index layer 5 (see FIG. 8B).

The display element 1B of this embodiment is configured in such a manner that a lower substrate 200 in which the liquid crystal panel 20 with the liquid crystal layer 24 interposed between the first substrate 22 including the first polarization plate 21 on the backlight 10 side and the second substrate 26 including the second polarization plate 27 on the observer side is used as a support, and the band pass filter 6 is formed on the observer side, and an upper substrate 300 in which the substrate 3 including the color filter layer 11 and the phosphor layer 4 formed thereon is used as a support, i.e., glass surfaces of the upper substrate 300 and the lower substrate 200 are directly bonded by the peripheral sealing material S2. A uniform gap is held between the phosphor layer 4 and the band pass filter 6 using the light extraction structure 9 as a spacer and the low refractive index layer 5 is formed (see FIG. 8A).

Further, in order to prevent peripheral portions of, for example, the color filter layer 11, the phosphor layer 4, the polarization plate 27 and the band pass filter 6 from coming in contact or interfering with the peripheral sealing material S2, it is preferable to provide a certain gap K in a border portion between the peripheral sealing material S2 and, for example, the color filter layer 11, the phosphor layer 4, the polarization plate 27 and the band pass filter 6 (see FIG. 8B).

(2) Operation and Effects of the Display Element

However, the color filter layer 11 or the phosphor layer 4 constituting the upper substrate 300 and the polarization plate 27 or the band pass filter 6 constituting the lower substrate 200 are both formed of organic films. Particularly, since the polarization plate 27 or the band pass filter 6 is formed by laminating a bonding layer, an adhesive layer, or a resin layer such as a PET (polyethylene terephthalate) base or a PVA (polyvinyl alcohol) film, the polarization plate 27 or the band pass filter 6 has a different linear expansion coefficient from the glass substrate. When the peripheral sealing material is adhered to these organic films, there is a possibility of warpage or positional displacement occurring in the substrate due to shrinkage of the organic film.

Since the display element 1B according to this embodiment has a configuration in which the glass surfaces of the substrates are directly adhered by the peripheral sealing material S2 on the outer side of these organic films, it is possible to prevent warpage or positional displacement of the substrate from occurring due to the shrinkage of the organic film.

According to the display element 1B of this embodiment, the low refractive index layer 5 is arranged between the phosphor layer 4 and the band pass filter 6. Accordingly, if light on the backlight 10 side emitted isotropically within the phosphor layer 4 is incident on the low refractive index layer 5, the light is totally reflected, scattered by the light extraction structure 9 or a scatterer in the color filter 11, and emitted to the outside, that is, an observer side.

Therefore, according to the display element of this embodiment, it is possible to efficiently extract the excitation light emitted isotropically within the phosphor layer 4 toward the observer.

### Third Embodiment

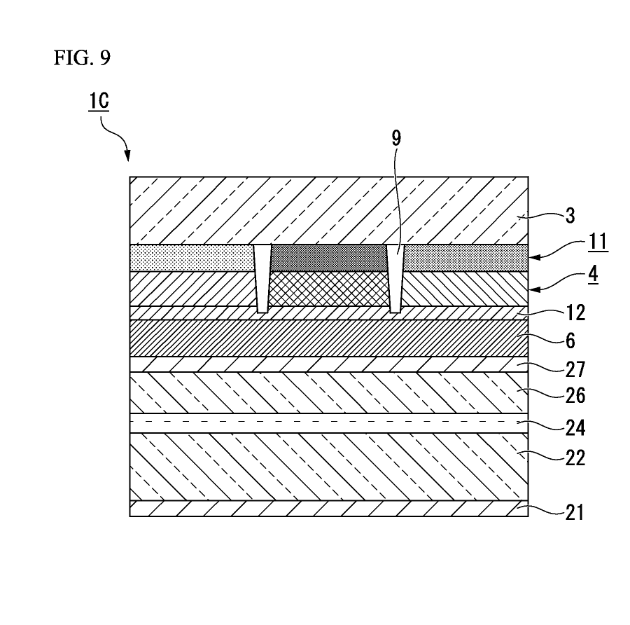

Hereinafter, a display element 1C of a third embodiment of the present invention will be described using FIG. 9.

A basic configuration of the display element 1C of this embodiment is the same as that of the display element 1 of the first embodiment, and the third embodiment is different from the first embodiment in that a low refractive index resin layer 12 is arranged between a phosphor layer 4 and a band pass filter 6 instead of the air layer.

FIG. 9 is a schematic cross-sectional view illustrating primary portions of the display element 1C of this embodiment. The same components in FIG. 9 as those in FIG. 1 of the first embodiment are denoted with the same reference signs and a detailed description thereof is omitted.

In the display element 1C of this embodiment, the low refractive index resin layer 12 is arranged between the phosphor layer 4 and the band pass filter 6, as illustrated in FIG. 9. For the low refractive index resin layer 12, for example, a porous film such as nanoporous silica or mesoporous silica, which is a material having a smaller refractive index than the phosphor layer 4 or the band pass filter 6, or a fluorine-based resin may be used. For example, mesoporous silica (Sumitomo Osaka Cement Co., Ltd.) and Mesoporous (Nippon Kasei Chemical Co., Ltd.) have a refractive index of about 1.18 to about 1.27, which is smaller than the refractive index of the phosphor layer 4 or the band pass filter 6, and are suitable as the low refractive index resin layer 12. For the fluorine-based resin, for example, Cytop (Asahi Glass Corporation) has a refractive index 1.34 and is similarly suitable as the low refractive index resin layer 12.

In addition, a porous silicon film may be formed by a sol-gel reaction using a reactive alkoxy silane as a starting raw material.

(2) Operation and Effects of the Display Element

According to the display element 1C of this embodiment, the low refractive index resin layer 12 formed of a medium having a smaller refractive index than the phosphor layer 4 or the band pass filter 6 is arranged between the phosphor layer 4 and the band pass filter 6. Accordingly, when light on the backlight 10 side emitted isotropically within the phosphor layer 4 is incident on the low refractive index resin layer 12, the light is totally reflected, scattered by the light extraction structure 9 or a scatterer in the color filter 11, and emitted to the outside, that is, an observer side.

Therefore, according to the display element of this embodiment, it is possible to efficiently extract the excitation light emitted isotropically within the phosphor layer 4 toward the observer.

### Variant of the Third Embodiment

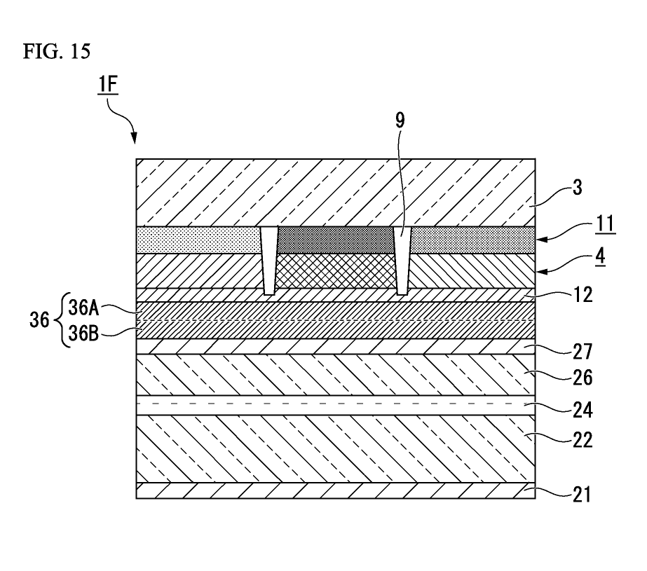

FIG. 15 is a cross-sectional view illustrating a variant of the display element of the third embodiment.

According to a display element 1F of this embodiment, a band pass filter 36 includes two layers including a low refractive index layer 36A and a dielectric multilayer film 3613. Also, an adhesive layer 37 is formed between the band pass filter 36, which includes the two layers, and a phosphor layer 4, which are bonded to each other.

In this embodiment, the band pass filter 36 is formed of a multilayer stretched film that is an organic material. In film multi-layering and stretching processes, a constituent material for the low refractive index layer 36A may be put into the outermost surface on one side to form a film, in addition to a high refractive index resin (PEN) and a low refractive index resin (PET) used for the dielectric multilayer film 36B.

In addition, in order to secure strength of such a film, it is also preferable for the outermost surface to be a PEN film layer, and to provide the low refractive index layer in an intermediate layer. For example, a fluorine-based polymer resin, or a polymer in which fine particles having a low refractive index are dispersed may be used as the material of the low refractive index layer 36A.

It is necessary for the low refractive index layer 36A to be formed to a sufficient thickness not to be involved in optical interference. For example, it is necessary for the thickness of the low refractive index layer 36A to be sufficiently greater than a wavelength region of a visible ray that ranges from 380 nm to 780 nm. Preferably, the thickness of the low refractive index layer 36A is 1 micron or more. According to such a configuration, it is not necessary for the adhesive layer of the phosphor layer 4 to have a low refractive index, and even when a normal adhesive layer is used for bonding, the low refractive index layer 36A installed in a portion (the outermost surface or the intermediate layer) of the band pass filter totally reflects an oblique fluorescent component, contributing to improvement of the light extraction efficiency. Therefore, it is possible to expect the same effects as those of the display element 1C of the third embodiment illustrated in FIG. 9.

### Fourth Embodiment

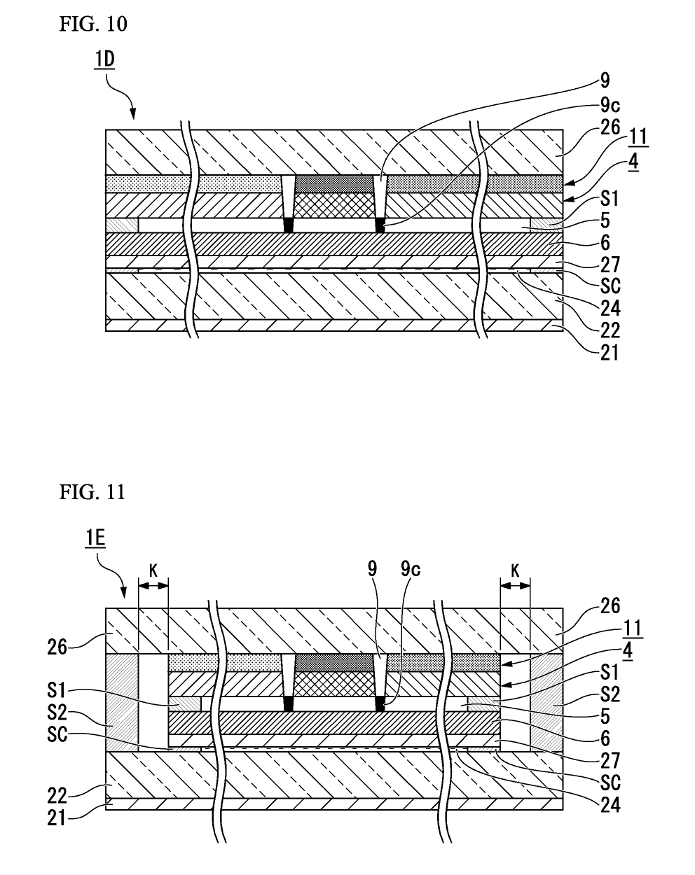

Hereinafter, a display element 1D of a fourth embodiment of the present invention will be described using FIG. 10.

A basic configuration of the display element 1D of this embodiment is the same as that of the display element 1 of the first embodiment, and the fourth embodiment is different from the first embodiment in that a substrate includes a first substrate 22 and a second substrate 26, and a band pass filter 6 and a polarization plate 27 are arranged in a liquid crystal panel.

FIG. 10 is a schematic cross-sectional view illustrating primary portions of the display element 1D of this embodiment. The same components in FIG. 10 as those in FIG. 1 of the first embodiment are denoted with the same reference signs and a detailed description thereof is omitted.

(1) Configuration of the Display Element

In the display element 1D of this embodiment, a first polarization plate 21, a first substrate 22, a liquid crystal layer 24, a second polarization plate 27, a band pass filter 6, a low refractive index layer 5, a phosphor layer 4, a color filter layer 11, and a second substrate 26 are laminated in this order from the backlight 10 (see FIG. 1) side, as illustrated in FIG. 10.

A light extraction structure 9, the color filter layer 11, and the phosphor layer 4 are laminated on the second substrate 26. The band pass filter 6 and the second polarization plate 27 are laminated on the first substrate 22 through a peripheral sealing material S1 and the low refractive index layer 5. In addition, a transparent electrode for liquid crystal driving or a light distribution film is arranged on the liquid crystal layer 24 side of the second polarization plate (not illustrated). Further, while an example of the light extraction structure 9 including an adhesive layer 9c to the band pass filter 6 in a protruding portion in the display element 1D illustrated in FIG. 10 is shown, the light extraction structure 9 is not limited thereto.

The first substrate 22, and the second substrate 26 on which the light extraction structure 9, the color filter layer 11 and the phosphor layer 4 are laminated are bonded through the liquid crystal layer 24 and sealed by a sealing material SC for a liquid crystal, such that a liquid crystal display element can be formed.

(2) Operation and Effects of the Display Element

According to the display element 1D of this embodiment, the low refractive index layer 5 is arranged between the phosphor layer 4 and the band pass filter 6. Accordingly, when the light on the backlight 10 side emitted isotropically within the phosphor layer 4 is incident on the low refractive index layer 5, the light is totally reflected, scattered by the light extraction structure 9 or a scatterer in the color filter 11, and emitted to the outside, that is, an observer side.

Therefore, according to the display element of this embodiment, it is possible to efficiently extract the excitation light emitted isotropically within the phosphor layer 4 toward the observer.

In addition, since the display element 1D of this embodiment has a so-called in-cell structure in which only two surfaces including the first substrate 22 and the second substrate 26 are used as a substrate, and the band pass filter 6 and the second polarization plate 27 are arranged within a liquid crystal cell, it is possible to suppress increase in thickness of the entire device. Further, it is possible to suppress increase in weight.

### Fifth Embodiment

Hereinafter, a display element 1E of a fifth embodiment of the present invention will be described using FIG. 11.

A basic configuration of the display element 1E of this embodiment is the same as that of the display element 1 of the first embodiment. This embodiment is different from the first embodiment in that a substrate includes only a first substrate 22 and a second substrate 26, a band pass filter 6 and a polarization plate 27 are arranged within a liquid crystal panel, and a peripheral sealing material is bonded to glass surfaces of the first substrate 22 and the second substrate 26.

FIG. 11 is a cross-sectional view illustrating primary portions of the display element 1E of this embodiment. The same components in FIG. 11 as those in FIG. 1 of the first embodiment are denoted with the same reference signs and a detailed description thereof is omitted.

(1) Configuration of the Display Element

The display element 1E of this embodiment includes a first polarization plate 21, the first substrate 22, a liquid crystal layer 24, the second polarization plate 27, the band pass filter 6, a low refractive index layer 5, a phosphor layer 4, a color filter layer 11, and the second substrate 26 laminated in this order from a backlight 10 (see FIG. 1) side, as illustrated in FIG. 11.

A light extraction structure 9, the color filter layer 11, and the phosphor layer 4 are laminated on the second substrate 26. The band pass filter 6 and the second polarization plate 27 are laminated on the first substrate 21 through the peripheral sealing material S1 and the low refractive index layer 5. In addition, for example, a transparent electrode for liquid crystal driving or a light distribution film is arranged on the liquid crystal layer side of the second polarization plate (not illustrated). In addition, the display element 1E illustrated in FIG. 11 shows an example of the light extraction structure 9 in which an adhesive layer 9c of the band pass filter 6 is included in a protruding portion, but the light extraction structure 9 is not limited thereto.

In the display element 1E of this embodiment, the glass surfaces of the second substrate 26 on which the light extraction structure 9, the color filter layer 11, and the phosphor layer 4 are laminated and the first substrate 22 on which the band pass filter 6 and the second polarization plate 27 are laminated through the peripheral sealing material and the low refractive index layer 5 are bonded directly by the peripheral sealing material S2.

In addition, a sealing portion of the liquid crystal layer 24 and a portion between the phosphor layer 4 and the band pass filter 6 can be sealed using respective dedicated sealing materials.

Further, in the display element 1E of this embodiment, the color filter layer 11, the phosphor layer 4, the low refractive index layer 5, the band pass filter 6 and the second polarization plate 27 are laminated in a space between the first substrate 22 and the second substrate 26, and a gap between the first substrate 22 and the second substrate 26 is large relative to a layer thickness of the liquid crystal layer 24. Therefore, it is possible to prevent an outflow of the liquid crystal material using a dedicated sealing material for the liquid crystal layer.

In order to prevent peripheral portions of, for example, the color filter layer 11, the phosphor layer 4, the polarization plate 27 and the band pass filter 6 from coming in contact or interfering with the peripheral sealing material S2, a certain gap K can be provided in a border portion between the peripheral sealing material S2 and, for example, the color filter layer 11, the phosphor layer 4, the polarization plate 27 and the band pass filter 6.

(2) Operation and Effects of the Display Element

However, the color filter layer 11 or the phosphor layer 4 laminated on the second substrate 26 and the polarization plate 27 or the band pass filter 6 laminated on the first substrate 22 are both formed of organic films. Particularly, since the polarization plate 27 or the band pass filter 6 is formed by laminating a bonding layer, an adhesive layer, or a resin layer such as a PET (polyethylene terephthalate) base or a PVA (polyvinyl alcohol) film, the polarization plate 27 or the band pass filter 6 has a different linear expansion coefficient from a glass substrate. When the peripheral sealing material S2 is adhered to these organic films, there is a possibility of warpage or positional displacement occurring in the substrate due to shrinkage of the organic film.

Since the display element IE according to this embodiment has a configuration in which the glass surfaces of the first substrate 22 and the second substrate 26 are directly adhered by the peripheral sealing material S2 on the outer side of these organic films, it is possible to prevent warpage or positional displacement of the substrate from occurring due to the shrinkage of the organic film.

According to the display element 1E of this embodiment, the low refractive index layer 5 is arranged between the phosphor layer 4 and the band pass filter 6. Accordingly, if light on the backlight 10 side emitted isotropically within the phosphor layer 4 is incident on the low refractive index layer 5, the light is totally reflected, scattered by the light extraction structure 9 or a scatterer in the color filter 11, and emitted to the outside, that is, an observer side.

Therefore, according to the display element of this embodiment, it is possible to efficiently extract the excitation light emitted isotropically within the phosphor layer 4 toward the observer.

In addition, while the example in which the light extraction structure 9 is formed to protrude at least 1 μm or more from the band pass filter 6 side of the phosphor layer 4 so that a gap between the phosphor layer 4 and the band pass filter 6 is maintained constant, and functions as a spacer holding the low refractive index layer 5 (air layer) therein has been described in each embodiment described above, one end of the light extraction structure 9 may be formed to be coplanar with one surface on the band pass filter 6 side of the phosphor layer 4, and the gap of the low refractive index layer 5 may be maintained constant by arranging another spacer. Specifically, a phosphor may be dropped into the light extraction structure subjected to hydrophilic treatment and water-repellent treatment, and patterning may be performed using a difference in wettability.

It is possible to bond the phosphor layer 4 and the band pass filter 6 in parallel with higher precision by bonding them using such a method.

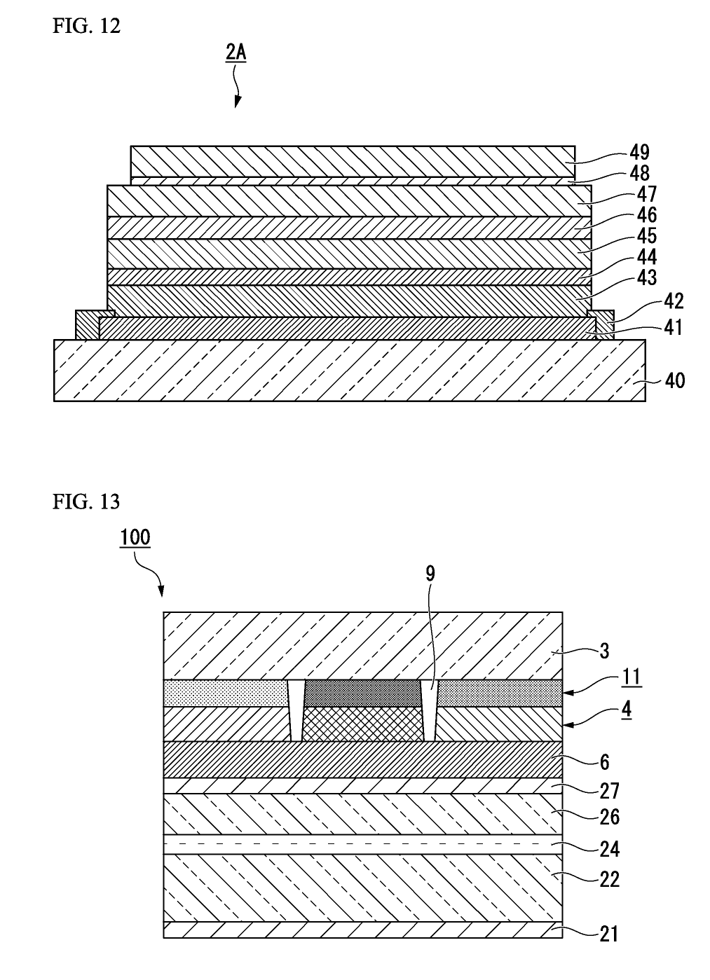

Further, while the configuration in which the backlight 10 and the liquid crystal panel 20 are included as the optical modulation portion 2 has been described in each embodiment described above, the present invention is not limited thereto. For example, a blue light emitting EL element 2A may be used as the optical modulation portion, as illustrated in FIG. 12.

For the blue light emitting EL element 2A used in this embodiment, a known organic EL may be used. The blue light emitting EL element 2A, for example, is a light emitting element having a configuration in which an anode 41, a hole injection layer 43, a hole transport layer 44, a light emitting layer 45, a hole blocking layer 46, an electron transport layer 47, an electron injection layer 48, and a cathode 49 are sequentially laminated on one surface of the substrate 40. An edge cover 42 is formed to cover the end surface of the anode 41. The blue light emitting EL element 2A may include an organic EL layer that includes a light emitting layer (an organic light emitting layer) 45 formed of at least an organic light emitting material between the anode 41 and the cathode 49, and a specific configuration thereof is not limited to the above configuration.

The blue light emitting EL element 2A is provided in a matrix form to correspond to each of the subpixels 8R, 8G and 8B illustrated in FIG. 1, and is adapted to be individually turned on/off. A method of driving the blue light emitting EL element 2A may be an active matrix driving method or may be a passive matrix driving method.

The blue light emitting EL element 2A is electrically connected to an external driving circuit. In this case, the blue light emitting EL element 2A may be directly connected to and driven by the external driving circuit, or a switching circuit such as a TFT may be arranged in a pixel and an external driving circuit (a scanning line electrode circuit (source driver), a data signal electrode circuit (gate driver), and a power supply circuit) may be electrically connected to a wiring to which, for example, the TFT is connected.

Further, while the case in which the blue light emitting EL element is the blue light emitting organic EL element has been described in this embodiment, the blue light emitting EL element may be a blue light emitting inorganic EL element.

Further, while the blue light emitting EL element has been illustrated as the optical modulation portion in this embodiment, the present invention is not limited thereto and an ultraviolet light emitting EL element (ultraviolet light emitting organic EL element or an ultraviolet light emitting inorganic EL element) may be used.

Further, while the configuration including the light source and the liquid crystal element, and the blue light emitting EL element have been illustrated as the optical modulation portion in the embodiments described above, for example, an MEMS (Micro Electro Mechanical Systems) display may be used instead. In addition, an optical switch device such as a digital mirror device (DMD) may also be used.

One embodiment of an illumination device including the display element as described above is shown below.

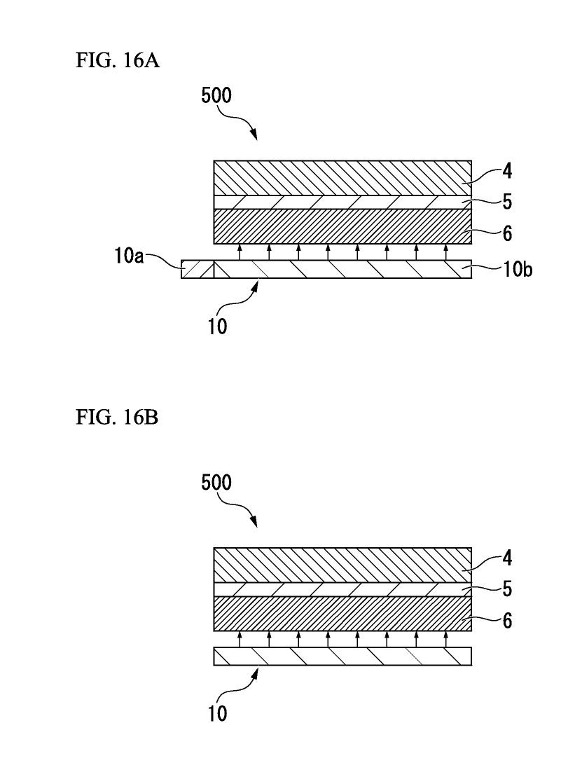

FIGS. 16A and 16B are cross-sectional views illustrating one embodiment of an illumination device. This illumination device 500 includes the display element 1 illustrated in FIG. 1. In other words, the illumination device 500 includes a phosphor layer 4, a band pass filter 6, and a low refractive index layer 5 arranged between the phosphor layer 4 and the band pass filter 6. Further, the illumination device 500 includes a backlight (light source) 10 that is a light source.

The backlight (light source) 10 has a configuration in which light of a light emitting body 10a provided in one end is spread in a surface shape by a light guide body 10b, as illustrated in FIG. 16A, or a backlight (light source) 10 that is a surface light emitting body may be used, as illustrated in FIG. 16B. The backlight (light source) 10 may be, for example, a blue light source. For the backlight (light source) 10, a blue light emitting organic EL light emitting body may be used. For example, when an active matrix organic EL light emitting body is used, a surface light source of area light control can be obtained. In addition, the surface light source of area light control can be obtained even when a liquid crystal element is used. Also, it is possible to improve light extraction efficiency by using the low refractive index layer 5 between the phosphor 4 and the band pass filter 6. For the phosphor 4, a phosphor (e.g., YAG) that converts a blue light source into white may be used, and a desired color such as red or green can also be developed.

### INDUSTRIAL APPLICABILITY

The present invention is applicable in the field of display elements.

### REFERENCE SYMBOLS

1, 1A, 1B, 1C, 1D, 1E . . . display element,
2 . . . optical modulation portion,
2A . . . blue light emitting EL element,
3, 22, 26, 40 . . . substrate,
4 . . . phosphor layer,
5 . . . low refractive index layer,
6 . . . band pass filter,
9 . . . light extraction structure,
10 . . . backlight (light source),
11 . . . color filter layer,
12 . . . low refractive index resin layer,
20 . . . liquid crystal panel (optical modulation element),
21 . . . first polarization plate,
24 . . . liquid crystal layer,
27 . . . second polarization plate,
S1, S2 . . . peripheral sealing material,
SC . . . liquid crystal sealing material

1. A display element comprising:
a light source;
a phosphor layer configured to absorb light from the light source as excitation light and generate light in a wavelength region different from a wavelength region of the light source;
a functional optical film configured to reflect the light emitted from the phosphor layer; and
a light extraction structure having a function of emitting the light emitted from the phosphor layer to a non-light source,
wherein the functional optical film is a band pass filter formed of a dielectric multilayer film, and a low refractive index layer is provided between the phosphor layer and the band pass filter.

2. The display element according to claim 1,
wherein the light source has at least one maximum value in a range of wavelengths from 400 nm to 490 nm in an emission spectrum, and
the functional optical film is a band pass filter including a dielectric multilayer film, having a region showing maximum transmittance in the range of wavelengths from 400 nm to 490 nm within a transmission spectrum and having a reflection band in a region of longer wavelengths than a wavelength of 490 nm.

3. The display element according to claim 1, wherein the low refractive index layer is an air layer.

4. The display element according to claim 1, wherein the low refractive index layer is a resin layer.

5. A display element comprising:
a light source;
a light control element configured to control an amount of light from the light source;
a phosphor layer configured to absorb the light transmitted through the light control element as excitation light, and generate light in a wavelength region different from a wavelength region of the light source;
a functional optical film configured to reflect the light emitted from the phosphor layer; and
a light extraction structure having a function of emitting the light emitted from the phosphor layer to a non-light source,
wherein the light source has at least one maximum value in a range of wavelengths from 400 nm to 490 nm within an emission spectrum, and the light control element is a liquid crystal element interposed between a pair of polarization plates, and
the functional optical film is a band pass filter including a dielectric multilayer film, having a region showing maximum transmittance in the range of wavelengths from 400 nm to 490 nm within a transmission spectrum, and having a reflection band in a region of longer wavelengths than a wavelength of 490 nm.

6. The display element according to claim 1, wherein the light extraction structure protrudes to one surface of the phosphor layer and comes in contact with one surface of the band pass filter, and the low refractive index layer arranged between the phosphor layer and the band pass filter is sealed in a periphery.

7. The display element according to claim 1, wherein the light extraction structure protrudes to one surface of the phosphor layer and comes in contact with one surface of the band pass filter, and the low refractive index layer arranged between the phosphor layer and the band pass filter includes an opening in a periphery.

8. The display element according to claim 1, wherein the light extraction structure includes an adhesive layer protruding to the one surface of the phosphor layer and comes in contact with one surface of the band pass filter, and the low refractive index layer arranged between the phosphor layer and the band pass filter is sealed in a periphery.

9. The display element according to claim 1, wherein the low refractive index layer and the band pass filter are interposed between the one surface of the first substrate on which the phosphor layer is formed and one surface of the second substrate supporting the light control element, and the surfaces are bonded with a sealing material.

10. The display element according to claim 1, wherein the low refractive index layer and the band pass filter are interposed between one surface of the first substrate on which the phosphor layer is formed and one surface of the second substrate supporting the light control element, the surfaces are bonded with a sealing material, and a periphery of the phosphor layer and a periphery of the band pass filter have a gap with the sealing material.

11. The display element according to claim 1, wherein the phosphor layer, the low refractive index layer and the band pass filter are interposed and arranged between one surface on the light source side of the substrate on the non-light source side of the light control element interposed and arranged between a pair of substrates and a polarization plate on the non-light source side of the light control element.

12. The display element according to claim 1, wherein
the phosphor layer, the low refractive index layer and the band pass filter are interposed and arranged between one surface on the light source side of the substrate on the non-light source side of the light control element interposed and arranged between a pair of substrates and a polarization plate on the non-light source side of the light control element, and
one surface of the substrate on the non-light source side on which the phosphor layer is formed and one surface of the substrate on the light source supporting the light control element are adhered with a sealing material.

13. The display element according to claim 1,
wherein the phosphor layer, the low refractive index layer and the band pass filter are interposed and arranged between one surface on the light source side of the substrate on the non-light source side of the light control element interposed and arranged between a pair of substrates and a polarization plate on the non-light source side of the light control element,
one surface of the substrate on the non-light source side on which the phosphor layer is formed and one surface of the substrate on the light source supporting the light control element are adhered with a sealing material, and
a periphery of the phosphor layer and a periphery of the band pass filter have a gap with the sealing material.

14. The display element according to claim 5,
wherein the functional optical film is a band pass filter including a dielectric multilayer film, having a region showing maximum transmittance in the range of wavelengths from 400 nm to 490 nm within a transmission spectrum, having a reflection band in a region of longer wavelengths than a wavelength of 490 nm, and reflecting light between 490 nm and 1000 nm for light at an incidence angle 0°.

15. A display element comprising:
a light source;
a light control element configured to control an amount of light from the light source;
a phosphor layer configured to absorb the light transmitted through the light control element as excitation light, and generate light in a wavelength region different from a wavelength region of the light source;
a functional optical film configured to reflect the light emitted from the phosphor layer; and
a light extraction structure having a function of emitting the light emitted from the phosphor layer to a non-light source,
wherein the functional optical film is a band pass filter including a dielectric multilayer film, having a region showing maximum transmittance in the range of wavelengths from 400 nm to 490 nm within a transmission spectrum and having a reflection band in a region of longer wavelengths than a wavelength of 490 nm, and
the light control element includes an MEMS.

16. (canceled)

17. The display element according to claim 1, wherein the band pass filter is a dielectric multilayer film using an organic film.

18. The display element according to claim 1,
wherein the band pass filter includes the low refractive index layer and the dielectric multilayer film that are formed integrally,
the low refractive index layer has a refractive index lower than any of a high refractive index layer and a low refractive index layer constituting the dielectric multilayer film, and
a film thickness of the low refractive index layer is greater than a wavelength of a visible light region.

19. (canceled)
